(19) United States
(12) Patent Application Publication
(10) Pub. No.: US 2018/0020642 A1
(43) Pub. Date: Jan. 25, 2018

(54) ANIMAL WASTE BAG

(71) Applicant: FARAH NICOLAS, VALLEY STREAM, NY (US)

(72) Inventor: FARAH NICOLAS, VALLEY STREAM, NY (US)

(21) Appl. No.: 15/643,216

(22) Filed: Jul. 6, 2017

Related U.S. Application Data
(60) Provisional application No. 62/493,473, filed on Jul. 6, 2016.

(51) Int. Cl. A01K 23/00

(52) U.S. Cl. CPC A01K 23/00

(57) ABSTRACT

A device for attaching to an animal and capturing feces therefrom is described. The device may have a bag, a material in a circular shape, the material having a center containing a cutout, the cutout forming an inner diameter, the circular shape having at least four elongated straps radiating away from an outer diameter of the circular shape. In at least some embodiments, the at least four elongated straps and the circular shape are integrally formed and the circular shape has an attachment mechanism for the bag.

### CLAIM OF PRIORITY

This application claims priority U.S. application Ser. No. 62/493,473, filed on Jul. 6, 2016, the contents of which are herein fully incorporated by reference in its entirety.

### FIELD OF THE EMBODIMENTS

The field of the embodiments relate to a container for collecting animal waste product, that is worn by the animal, and doesn't require the animal's keeper to scoop up the waste.

### BACKGROUND OF THE EMBODIMENTS

One of the most frustrating parts of owning a pet, particularly a dog, is having to go on early morning walks and wait for the beloved pooch to squat and defecate and then pick up the feces into a plastic bag, and walk around with the bag, until a trash receptacle is found. Leaving the feces on the ground is not option. Fines and social norms dictate that the feces have to be picked up and cleaned up. The trouble of having to bend down and pick up the feces makes people reluctant to do so, further it makes a professional dog walkers job harder by having to bend down to pick up multiple dogs' feces. A number of concepts have attempted to make the process easier by integrating a bag into a wearable device, but have not had full success in making it easy to put the device onto the dog and to further take the bag off and put it on. Examples of related art are described below.

U.S. Pat. No. 5,937,795 pertains to a device for attaching to a pet and capturing feces and urine therefrom that includes an adjustable collar, an adjustable harness, a feces receptacle, and a urine receptacle. The collar releasably and adjustably encircles the neck of the pet. The adjustable harness is releasably attached to the adjustable collar and replaceably engages the pet. The feces receptacle is detachably mounted to the adjustable harness and is disposed below and captures the feces from the anus of the pet. The urine receptacle is separate from the feces receptacle and is detachably mounted to the adjustable harness and is disposed in proximity of and captures urine from the genitals of the pet.

U.S. Pat. No. 5,146,874 pertains to garment of flexible, light weight, soft and strong material, to be worn on the body by dogs, cats, mammals or the like, provided with pouches for receiving and retaining, when in use, the discharge of their solid and fluid wastes respectively. The garment comprises a wearer-contacting garment with one pouch located around the root of the tail and the anal region of the wearer, said pouch having a closed bottom and an entrance opening to receive and retain solid body wastes and one pouch located over and around the genitalia of the wearer, having an absorbent pad positioned therein to receive and retain fluid body wastes.

However, none of the art described above addresses all of the issues that the embodiments of the present invention do. The present application makes it easier to use bags and harnesses, by making it easier to put the device onto the pet. The present application describes a device for attaching to an animal and capturing their feces using a bag, a material in a circular shape, the material having a center with a cutout, the circular shape having at least four straps radiating away from the circular shape, with the at least four elongated straps and the circular shape being integrally formed, and the circular shape having an attachment mechanism for the bag.

### SUMMARY OF THE EMBODIMENTS

Embodiments of the present invention include a device for attaching to an animal and capturing feces therefrom, having a bag, a material in a circular shape, the material having a center containing a cutout, the cutout forming an inner diameter, the circular shape having at least four elongated straps radiating away from an outer diameter of the circular shape, with the at least four elongated straps and the circular shape being integrally formed, and the circular shape having an attachment mechanism for the bag.

It is an object of the embodiments of the present invention to have the straps and the circular shape be made of one single sheet of material, in that they can be cut from the same sheet and there are no seams or joints connecting the straps and the central circular piece.

It is another object of the embodiments of the present invention to have two of the straps radiate in different directions from one half of the outer diameter of the circular shape and have an acute angle, of no more than thirty degrees, between the two straps and two other straps radiate from another half of the outer diameter of the circular shape. In another embodiment the straps can also radiate in parallel directions.

It is another object of the embodiments of the present invention to have the straps run the length of the animals' body and be joined as one strap during the torso position. The straps can loop around the neck or the torso of the animal.

It is yet another object of the embodiments of the present invention to have straps connect to each other at their respective distal ends using a mechanism such a hook and loop, or a snap fit. The straps can also connect at each other's midpoints.

It is yet another object of the embodiments of the present invention to have the straps be approximately 1 to 8 feet in length, wherein the straps can be made of an elastic material or a woven material.

It is yet another object of the embodiments of the present invention to have the bag be approximately 1 to 4 liters in volume. The bag can further be attached by an adhesive to the circular portion of the device, with the adhesives being located on the bag, or the bag can be attached using a hook and loop system.

### BRIEF DESCRIPTION OF THE DRAWINGS

FIG. 1a shows a top perspective view of an embodiment of the invention in use.

FIG. 1b shows a side perspective view of an embodiment of the invention in use.

FIG. 2 shows a perspective view of an embodiment of the invention.

FIG. 3 shows a back perspective view of an embodiment of the invention.

FIG. 4 shows a front view of an embodiment of the invention.

FIG. 5 shows a side view of an embodiment of the invention.

FIG. 6 shows another side view of an embodiment of the invention.

FIG. 7 shows a front view of an embodiment of the invention with straps connected.

FIG. 8 shows a top perspective view of an embodiment of the invention.

FIG. 9 shows a bottom perspective view of an embodiment of the invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

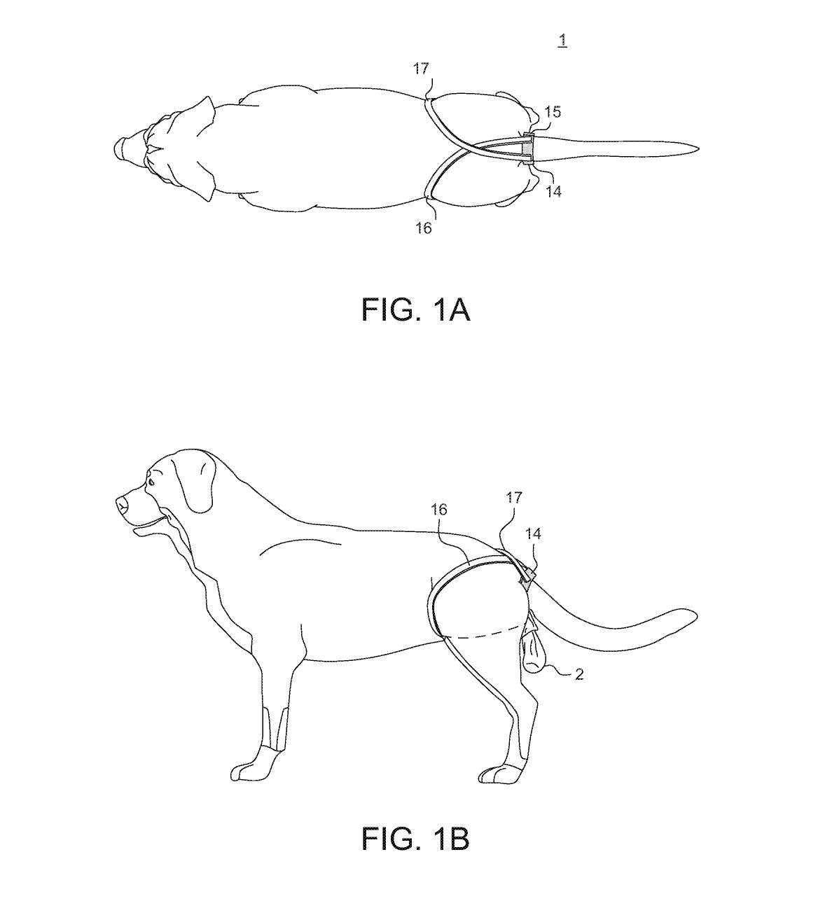

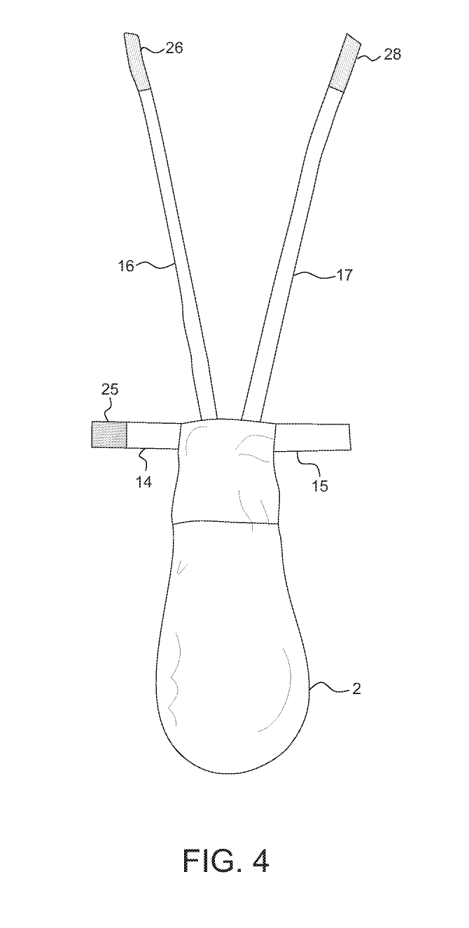

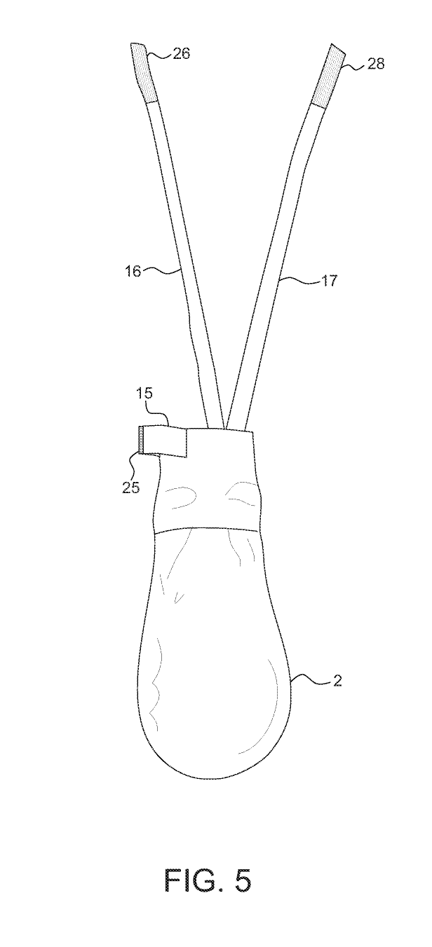

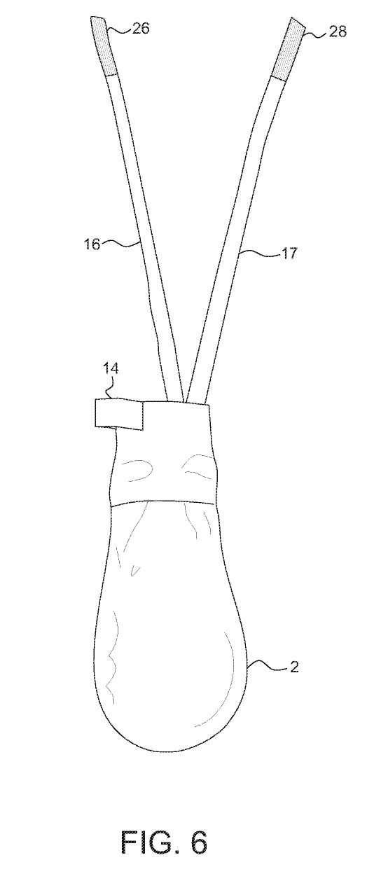

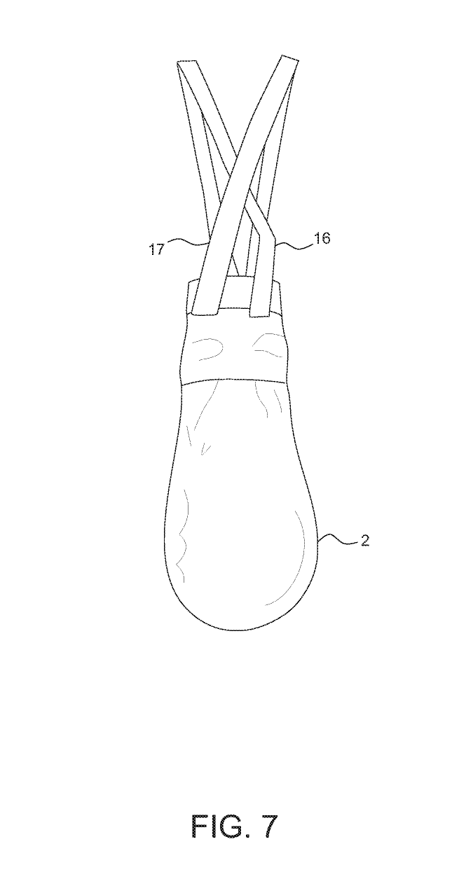

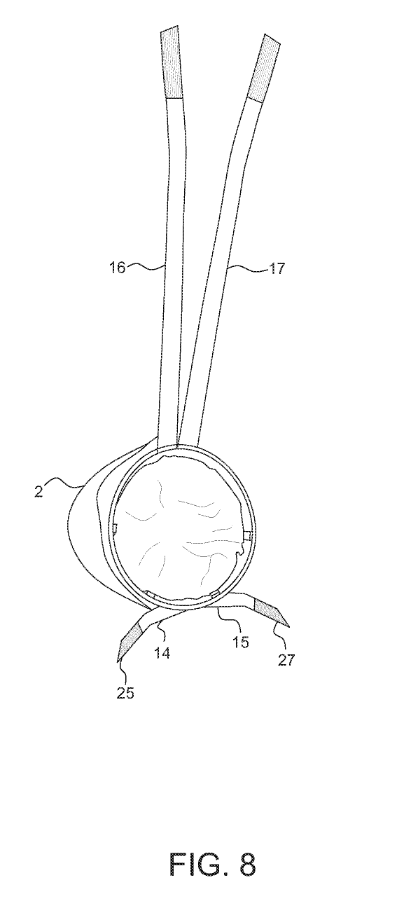

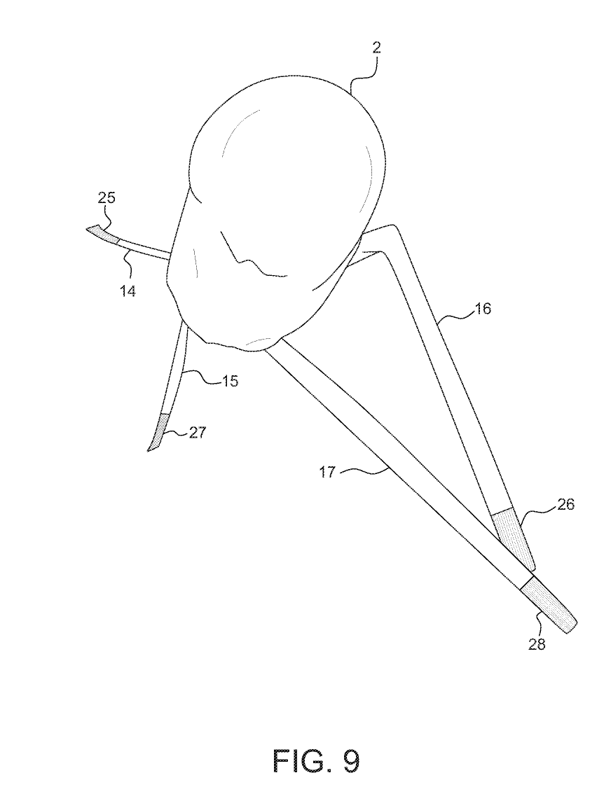

As can be seen from FIGS. 1a-9, displayed are embodiments of a device 1 for attaching to an animal, particularly a dog, and capturing feces therefrom. The device 1 may have a bag 2, a material in a circular shape, the material having a center containing a cutout, the cutout forming an inner diameter, the circular shape having at least four elongated straps radiating away from an outer diameter of the circular shape, wherein the at least four elongated straps and the circular shape are integrally formed and the circular shape having an attachment mechanism for the bag. The first 16 and second straps 17, are meant to go around the tail of the dog and cross each other on the dog's back.

In the top view of the embodiment, the device 1 is attached on the rear end of an animal. The cutout 4, can be placed over the anus of the animal. The cutout 4 should be large enough such that when the anus expands to allow the feces out, the material is not in the way and does not get soiled by the excrement.

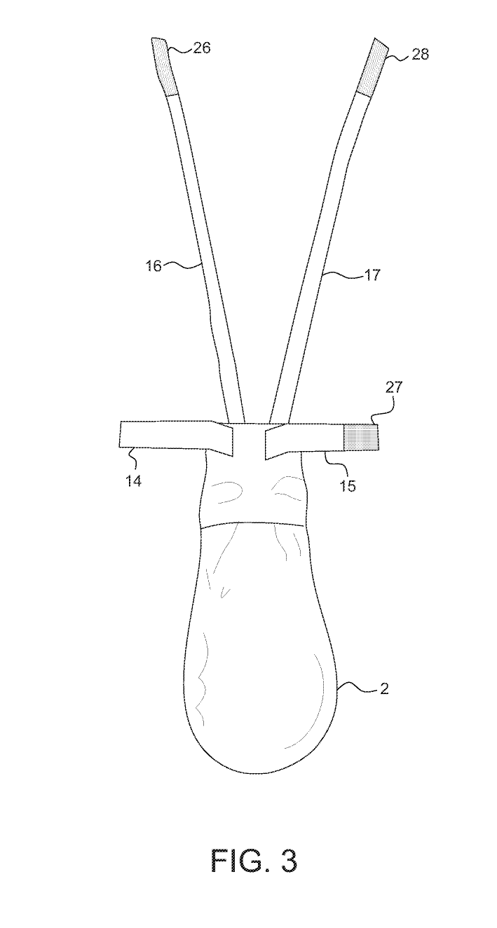

The device 1 can have at least four elongated straps with a first strap 16 and second 17 strap radiating from a bottom half of the outer diameter of the circular shape (as can be seen in FIG. 3), wherein the first strap 16 and the second strap 17 radiate in different directions.

As further seen in FIG. 3, the first strap 16 and the second strap 17 have an angle between an inner side of the first strap 16 and an inner side of the second strap 17, having a meeting point on the outer diameter. The third strap 14 and the fourth strap 15 can radiate from the top half of the outer diameter of the circular shape, wherein an inner side of the third strap 14 and an inner side of the fourth strap join at a point on the outer diameter of the circular shape.

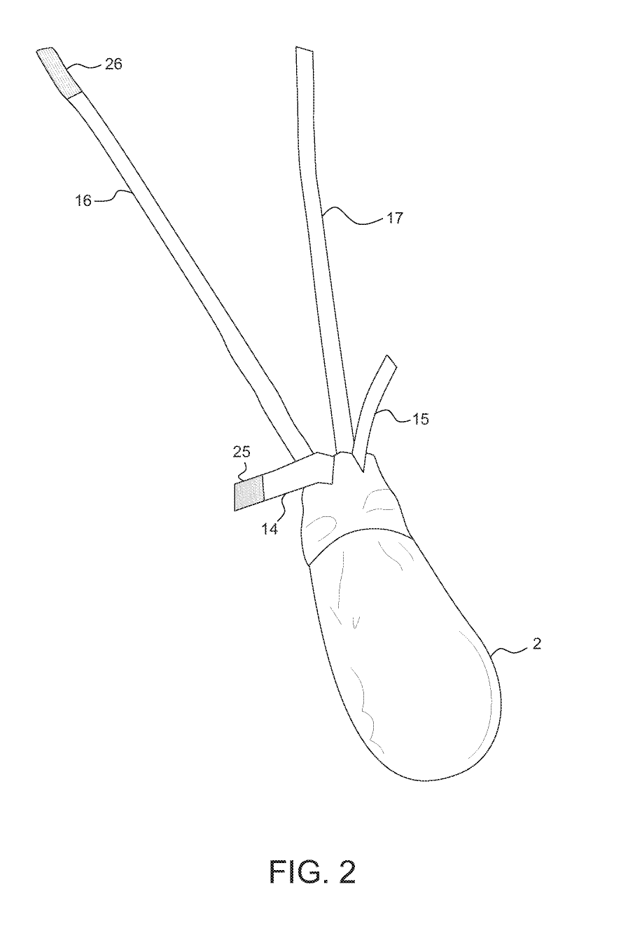

As further seen in FIG. 2, the first strap 16 can have a first attachment mechanism 26 disposed thereon a distal end and the second strap 17 can have a second attachment mechanism 28 disposed thereon a distal end as seen in FIG. 3. The third strap 14 can have a third attachment 25 mechanism at a distal end and the fourth strap can have a fourth attachment mechanism 27 at a distal end. First 16 and second 17 straps go on the underside and back of the dog, and are attached relatively to the fourth and third straps.

As further seen in FIG. 3, the angle between the inner side of the first strap 16 and the inner side of the second strap 17 is an acute angle, the angle should be no larger than degrees. The size of the angle allows the straps to be pointed in the proper direction while also being wide enough and avoiding the genitalia of the dog and not getting soiled when the dog urinates.

The device 1 should have straps of 1 to 8 feet in length depending on the size of the animal. The animal can be as small as a lap dog to as large as a horse. The straps and the circular shape can be formed of a single piece of material, such that there are no seams or joints connecting them. This makes some aspects of manufacturing easier, wherein the shapes can be simply stamped out a single sheet or even be cast. The straps and the circular shape can be made of a stretchable elastic material or a woven material.

Further, the device can have a bag 2 of approximately 1 to 4 liters in volume, depending on the size of the animal. The bag can be attached to the circular shape, and removed when filled. The bag 2, can be attached using an adhesive. The adhesive can be on the outer portion of the bag, such that the dog's fur and tail don't stick to the outer shape, when the bag is not attached. Also, the bag 2, can be attached to the circular shape, using a hook and loop system. The device mentioned above allows the pet owners to keep the device on the pet as a harness or a collar and only switch bags out when going out for a walk.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A device for attaching to an animal and capturing feces therefrom, the device comprising: a bag;
a material in a circular shape,
wherein the material has a center containing a cutout with the cutout forming an inner diameter,
wherein the circular shape has at least four elongated straps radiating away from an outer diameter of the circular shape, and
wherein the at least four elongated straps and the circular shape are integrally formed; and
an attachment mechanism coupled to the circular shape,
wherein the attachment mechanism is configured to secure a position of the bag.

2. The device of claim 1, wherein the at least four elongated straps and the circular shape are comprised of a single sheet of the material.

3. The device of claim 1, wherein the at least four elongated straps comprise a first strap, a second strap, a third strap, and a fourth strap, wherein the first strap and the second strap radiate from a bottom half of the outer diameter of the circular shape, wherein the first strap and the second strap radiate in different directions.

4. The device of claim 3, wherein the first strap and the second strap have an angle between an inner side of the first strap and an inner side of the second strap, having a meeting point on the outer diameter of the inner side of the first strap and an inner point of the second strap, and
wherein the third strap and the fourth strap radiate from the top half of the outer diameter of the circular shape, wherein an inner side of the third strap and an inner side of the fourth strap join at a point on the outer diameter of the circular shape.

5. The device of claim 3, wherein the first strap has a first attachment mechanism disposed thereon at a distal end of the first strap and the second strap has a second attachment mechanism disposed thereon at a distal end of the second strap, and wherein the third strap has a third attachment mechanism at a distal end of the third strap, and the fourth strap has a fourth attachment mechanism at a distal end of the fourth strap.

6. The device of claim 3, wherein the angle between the inner side of the first strap and the inner side of the second strap is an acute angle, and the inner side of the first strap and the inner side of the second strap meet at a point.

7. The device of claim 6, wherein the acute angle is a maximum of 30 degrees.

8. The device of claim 5, wherein the attachment mechanisms comprise a snap fit.

9. The device of claim 5, wherein the attachment mechanisms comprise a hook and loop attachment.

10. The device of claim 1, wherein the at least four elongated straps comprise a first strap, a second strap, a third strap, and a fourth strap, wherein the first strap and the second strap radiate from a bottom half of the outer diameter of the circular shape, wherein the first strap and the second strap radiate in a parallel direction to each other.

11. (canceled)

12. (canceled)

13. (canceled)

14. The device of claim 3, wherein each of the elongated straps is approximately 1 to 8 feet in length.

15. The device of claim 3, wherein the elongated straps comprise elastic material or a woven material.

16. The device of claim 1, wherein the bag is approximately 1 to 4 liters in volume.

17. The device of claim 1, wherein the attachment mechanism for the bag comprises an adhesive.

18. The device of claim 17, wherein the circular shape is free of an adhesive substance, and the bag contains the adhesive substance.

19. The device of claim 1, wherein the attachment mechanism for the bag is a hook and loop system.
